(19) United States
(12) Patent Application Publication
(10) Pub. No.: US 2008/0214709 A1
(43) Pub. Date: Sep. 4, 2008

(54) Polyurethane Dispersion Containing Alkanolamines

(75) Inventors: Ulrike Licht, Mannheim (DE); Denise von Preysing, Mannheim (DE); Karl-Heinz Schumacher, Neustadt (DE); Andre Burghardt, Idar-Oberstein (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/065,036

(22) PCT Filed: Aug. 31, 2006
(86) PCT No.: PCT/EP06/65872

§ 371 Date: Feb. 27, 2008

(30) Foreign Application Priority Data
Sep. 9, 2005 (DE) 10 2005 043 173.9

(51) Int. Cl. C08K 5/17

(52) U.S. Cl. 524/186

(57) ABSTRACT

A polyurethane dispersion whose polyurethane comprises anionic groups at least 10 mol % of which are neutralized by alkanolamines having at least two hydroxyl groups, excluding polyurethane dispersions comprising water-emulsifiable polyisocyanates.

The invention relates to a polyurethane dispersion whose polyurethane comprises anionic groups at least 10 mol % of which are neutralized by alkanolamines having at least two hydroxyl groups, excluding polyurethane dispersions comprising water-emulsifiable polyisocyanates.

The invention further relates to the use of the polyurethane dispersions as binders in adhesives, coating compositions, and impregnating compositions.

Polyurethane dispersions are frequently neutralized with tertiary amines such as triethylamine. Examples of known alternatives to triethylamine include alkali metal compounds, ammonia or other amines. Low molecular mass amines are generally volatile and therefore unwanted. Long-chain amines, which are of low volatility, are unsuitable for neutralizing anionic polyurethanes on account of the fact either that they produce only very coarse dispersions or that dispersion is completely impossible.

Ammonia can be utilized only in exceptional cases, since it reacts with the NCO end groups of the NCO-terminated prepolymer that is frequently prepared, and chains are terminated. Alkali metal bases make the film significantly harder and endow it with a permanent hydrophilicity. This impairs water resistance in a coating material and activatability in an adhesive.

Furthermore, for improved processing properties, there is a desire that the dispersions should have as low as possible a viscosity for a given solids content.

DE-A-37 39 332 names a range of different amines as neutralizing agents for polyurethane dispersions. Amines considered suitable there are in principle only those containing no isocyanate-reactive groups.

EP-A 806 443 discloses 2 K [2-component] polyurethane dispersions comprising the following constituents:

a) a polyurethane containing anionic groups,
b) a water-emulsifiable polyisocyanate, and
c) an alkanolamine.

The alkanolamine is used there as an addition to a polyurethane dispersion which has already been neutralized with other amines. At the margin there is also a reference to the effect that alkanolamines c) can also be neutralizing agents for the polyurethane a).

On the basis of the above prior art as represented by DE-A-37 39 332, however, the skilled worker will not interpret this reference as an actual technical teaching for action.

The object was to find neutralized polyurethane dispersions which do not have the stated disadvantages.

Found accordingly have been the above-defined polyurethane dispersion and its use. The polyurethane dispersion of the invention preferably comprises a polyurethane synthesized from
a) diisocyanates,
b) diols of which
b1) 10 to 100 mol %, based on the total amount of diols (b), have a molecular weight of 500 to 5000 g/mol and
b2) 0 to 90 mol %, based on the total amount of diols (b), have a molecular weight of 60 to 500 g/mol,
c) monomers other than the monomers (a) and (b), containing at least one isocyanate group or at least one isocyanate-reactive group and further carrying at least one anionic group by means of which the polyurethane is made dispersible in water, and
d) if appropriate, further, monofunctional or polyfunctional compounds other than the monomers (a) to (c), containing reactive groups which are alcoholic hydroxyl groups, primary or secondary amino groups or isocyanate groups.

Particular mention may be made as diisocyanates a) of those of the formula X(NCO)₂, where X is an aliphatic hydrocarbon radical having 4 to 12 carbon atoms, a cycloaliphatic or aromatic hydrocarbon radical having 6 to 15 carbon atoms, or an araliphatic hydrocarbon radical having 7 to 15 carbon atoms. Examples of such diisocyanates include tetramethylene diisocyanate, hexamethylene diisocyanate (HDI), dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene (TDI), 4,4′-diisocyanatodiphenylmethane, 2,4′-diisocyanatodiphenylmethane (MDI), p-xylylene diisocyanate, tetramethylxylylene diisocyanate (TMXDI), the isomers of bis(4-isocyanatocyclohexyl)methane (HMDI) such as the trans/trans, the cis/cis, and the cis/trans isomer, and mixtures of these compounds.

Disocyanates of this kind are available commercially.

Particularly important mixtures of these isocyanates are the mixtures of the respective structural isomers of diisocyanatotoluene and diisocyanatodiphenylmethane; the mixture of 80 mol % 2,4-diisocyanatotoluene and 20 mol % 2,6-diisocyanatotoluene is particularly suitable. Also of particular advantage are the mixtures of aromatic isocyanates such as 2,4-diisocyanatotoluene and/or 2,6-diisocyanatotoluene with aliphatic or cycloaliphatic isocyanates such as hexamethylene diisocyanate or IPDI, in which case the preferred ratio of the aliphatic to the aromatic isocyanates is from 4:1 to 1:4.

Compounds used to synthesize the polyurethanes, in addition to those mentioned above, also include isocyanates which in addition to the free isocyanate groups carry further, blocked isocyanate groups, e.g., uretdione groups or carbodiimide groups.

With a view to effective film-forming and elasticity, suitable diols (b) are principally relatively high molecular weight diols (b1), having a molecular weight of from about 500 to 5000, preferably from about 1000 to 3000 g/mol.

The diols (b1) are in particular polyesterpolyols, which are known, for example, from Ullmanns Encyklopädie der technischen Chemie, 4th edition, volume 19, pp. 62 to 65. It is preferred to use polyesterpolyols which are obtained by reacting dihydric alcohols with dibasic carboxylic acids. Instead of the free polycarboxylic acids it is also possible to use the corresponding polycarboxylic anhydrides or corresponding polycarboxylic esters of lower alcohols or mixtures thereof to prepare the polyesterpolyols. The polycarboxylic acids can be aliphatic, cycloaliphatic, araliphatic, aromatic or heterocyclic and can if appropriate be substituted, by halogen atoms for example, and/or unsaturated. Examples thereof include the following: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, and dimeric fatty acids. Preferred dicarboxylic acids are those of the formula HOOC—(CH₂)_{y}—COOH, where y is a number from 1 to 20, preferably an even number from 2 to 20, examples being succinic acid, adipic acid, sebacic acid, and dodecanedicarboxylic acid.

Examples of suitable polyhydric alcohols include ethylene glycol, propane-1,2-diol, propane-1,3-diol, butane-1,3-diol, butene-1,4-diol, butyne-1,4-diol, pentane-1,5-diol, neopentyl glycol, bis(hydroxymethyl)cyclohexanes such as 1,4-bis(hydroxymethyl)-cyclohexane, 2-methylpropane-1,3-diol, methylpentanediols, and also diethylene glycol, triethylene glycol, tetraethylene glycol, polyethylene glycol, dipropylene glycol, polypropylene glycol, and dibutylene glycol and polybutylene glycols. Preferred alcohols are those of the formula HO—(CH₂)ₓ—OH, where x is a number from 1 to 20, preferably an even number from 2 to 20. Examples of such include ethylene glycol, butane-1,4-diol, hexane-1,6-diol, octane-1,8-diol, and dodecane-1,12-diol. Preference is also given to neopentyl glycol.

Suitability is also possessed by polycarbonatediols, such as may be obtained, for example, by reacting phosgene with an excess of the low molecular weight alcohols specified as synthesis components for the polyesterpolyols.

Also suitable are lactone-based polyesterdiols, which are homopolymers or copolymers of lactones, preferably hydroxy-terminated adducts of lactones with suitable difunctional starter molecules. Preferred lactones are those derived from compounds of the general formula HO—(CH₂)_{z}—COOH where z is a number from 1 to 20 and where one hydrogen atom of a methylene unit may also be substituted by a C₁ to C₄alkyl radical. Examples are ε-caprolactone, β-propiolactone, γ-butyrolactone and/or methyl-ε-caprolactone, and mixtures thereof. Examples of suitable starter components are the low molecular weight dihydric alcohols specified above as a synthesis component for the polyesterpolyols. The corresponding polymers of ε-caprolactone are particularly preferred. Lower polyesterdiols or polyetherdiols as well can be used as starters for preparing the lactone polymers. Instead of the polymers of lactones it is also possible to use the corresponding chemically equivalent polycondensates of the hydroxycarboxylic acids corresponding to the lactones.

Further suitable monomers (b1) are polyetherdiols. They are obtainable in particular by polymerizing ethylene oxide, propylene oxide, butylene oxide, tetrahydrofuran, styrene oxide or epichlorohydrin with itself, in the presence of BF₃ for example, or by subjecting these compounds, if appropriate in a mixture or in succession, to addition reaction with starter components containing reactive hydrogen atoms, such as alcohols or amines, examples being water, ethylene glycol, propane-1,2-diol, propane-1,3-diol, 1,2-bis(4-hydroxydiphenyl)propane, and aniline. Particular preference is given to polytetrahydrofuran with a molecular weight of from 240 to 5000 g/mol-, and in particular of from 500 to 4500 g/mol-. Additionally mixtures of polyesterdiols and polyetherdiols can be used as monomers (b1).

Likewise suitable are polyhydroxyolefins, preferably those having 2 terminal hydroxyl groups, e.g., α,ω-dihydroxypolybutadiene, α,ω-dihydroxypolymethacrylic esters or α,ω-dihydroxypolyacrylic esters, as monomers (c1). Such compounds are known for example from EP-A 0 622 378. Further suitable polyols are polyacetals, polysiloxanes, and alkyd resins.

The polyols can also be used as mixtures.

The hardness and the elasticity modulus of the polyurethanes (I) can be increased by using as diols (b) not only the diols (b1) but also low molecular weight diols (b2) having a molecular weight of from about 60 to 500 g/mol, preferably from 62 to 200 g/mol.

Monomers (b2) used are in particular the synthesis components of the short-chain alkanediols specified for preparing polyesterpolyols, preference being given to diols having 2 to 12 carbon atoms, unbranched diols having 2 to 12 carbon atoms and an even number of carbon atoms, and also to pentane-1,5-diol and neopentyl glycol.

The fraction of the diols (b1), based on the total amount of diols (b), is preferably from 10 to 100 mol %, and the fraction of the monomers (b2), based on the total amount of diols (b), is preferably from 0 to 90 mol %. With particular preference the ratio of the diols (b1) to the diols (b2) is from 0.1:1 to 5:1, more preferably from 0.2:1 to 2:1.

In order to make the polyurethanes dispersible in water they comprise monomers (c), which carry at least one isocyanate group or at least one group reactive toward isocyanate groups (isocyanate-reactive group) and, furthermore, at least one anionic group.

The fraction of the components having anionic groups among the total quantity of components (a), (b), (c), and (d) is generally such that the molar amount of the anionic groups, based on the amount by weight of all monomers (a) to (d), is from 30 to 1000, preferably from 50 to 500, and more preferably from 80 to 300 mmol/kg of polyurethane.

The anionic groups are in particular the sulfonate, carboxylate, and phosphate group.

Suitable monomers having anionic groups, or acid groups converted into an anionic group by neutralization, normally include aliphatic, cycloaliphatic, araliphatic or aromatic carboxylic acids and sulfonic acids which carry at least one alcoholic hydroxyl group or at least one primary or secondary amino group.

Preference is given to dihydroxyalkylcarboxylic acids, especially those having 3 to 10 carbon atoms, such as are also described in U.S. Pat. No. 3,412,054. Particular preference is given to compounds of the general formula (c₁)

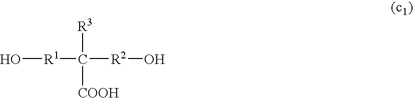

in which R¹ and R² are a C₁ to C₄alkanediyl unit and R³ is a C₁ to C₄ alkyl unit, and especially to dimethylolpropionic acid (DMPA).

Also suitable are corresponding dihydroxysulfonic acids and dihydroxyphosphonic acids such as 2,3-dihydroxypropanephosphonic acid.

Otherwise suitable are dihydroxyl compounds having a molecular weight of more than 500 to 10 000 g/mol and at least 2 carboxylate groups, which are known from DE-A 3 911 827. They are obtainable by reacting dihydroxyl compounds with tetracarboxylic dianhydrides such as pyromellitic dianhydride or cyclopentanetetracarboxylic dianhydride in a molar ratio of from 2:1 to 1.05:1 in a polyaddition reaction. Particularly suitable dihydroxyl compounds are the monomers (b2) cited as chain extenders and also the diols (b1).

Suitable monomers (c) containing amino groups reactive toward isocyanates include aminocarboxylic acids such as lysine, β-alanine or the adducts of aliphatic diprimary diamines with α,β-unsaturated carboxylic or sulfonic acids that are specified in DE-A 2034479.

Such compounds obey, for example, the formula (c₂)

H₂N—R⁴—NH—R⁵—X (c₂)

where
—R⁴ and R⁵ independently of one another are a C₁ to C₆alkanediyl unit, preferably ethylene
and X is COOH or SO₃H.

Particularly preferred compounds of the formula (c₂) are N-(2-aminoethyl)-2-aminoethanecarboxylic acid and also N-(2-aminoethyl)-2-aminoethanesulfonic acid.

Also preferred are the adducts of the abovementioned aliphatic diprimary diamines with 2-acrylamido-2-methylpropanesulfonic acid, as described for example in patent DE 1 954 090. Monomers c) likewise highly suitable are adducts of aliphatic diamines, ethylenediamine for example, or else propylenediamine with acrylates or methacrylates. At least 10 mol %, preferably at least 40 mol %, more preferably at least 70 mol %, very preferably at least 90 mol %, and in particular the entirety (100 mol %) of the anionic groups of the polyurethane are neutralized with an alkanolamine, and hence are present in salt form, the acid group being the anion and the cation being alkanolamine.

Neutralization with the alkanolamine may take place before, during or, preferably, after the isocyanate polyaddition.

The polyurethane may comprise further monomers (d), which are different from the monomers (a) to (c), as synthesis components. Monomers (d) serve for example for crosslinking or chain extension. They generally comprise nonphenolic alcohols with a functionality of more than 2, amines having 2 or more primary and/or secondary amino groups, and compounds which as well as one or more alcoholic hydroxyl groups carry one or more primary and/or secondary amino groups.

Alcohols having a functionality of more than 2, which may be used in order to set a certain degree of branching or crosslinking, include for example trimethylolpropane, glycerol, or sugars.

Polyamines having 2 or more primary and/or secondary amino groups are used especially when the chain extension and/or crosslinking is to take place in the presence of water, since amines generally react more quickly than alcohols or water with isocyanates. This is frequently necessary when the desire is for aqueous dispersions of crosslinked polyurethanes or polyurethanes having a high molar weight. In such cases the approach taken is to prepare prepolymers with isocyanate groups, to disperse them rapidly in water, and then to subject them to chain extension or crosslinking by adding compounds having two or more isocyanate-reactive amino groups.

Amines suitable for this purpose are generally polyfunctional amines of the molar weight range from 32 to 500 g/mol, preferably from 60 to 300 g/mol, which contain at least two amino groups selected from the group consisting of primary and secondary amino groups. Examples of such are diamines such as diaminoethane, diaminopropanes, diaminobutanes, diaminohexanes, piperazine, 2,5-dimethylpiperazine, amino-3-aminomethyl-3,5,5-trimethylcyclohexane (isophoronediamine, IPDA), 4,4′-diaminodi-cyclohexylmethane, 1,4-diaminocyclohexane, aminoethylethanolamine, hydrazine, hydrazine hydrate or triamines such as diethylenetriamine or 1,8-diamino-4-aminomethyloctane.

The amines can also be used in blocked form, e.g., in the form of the corresponding ketimines (see for example CA-A 1 129 128), ketazines (cf. e.g. U.S. Pat. No. 4,269,748) or amine salts (see U.S. Pat. No. 4,292,226). Oxazolidines as well, as used for example in U.S. Pat. No. 4,192,937, represent blocked polyamines which can be used for the preparation of the polyurethanes of the invention, for chain extension of the prepolymers. Where blocked polyamines of this kind are used they are generally mixed with the prepolymers in the absence of water and this mixture is then mixed with the dispersion water or with a portion of the dispersion water, so that the corresponding polyamines are liberated by hydrolysis.

It is preferred to use mixtures of diamines and triamines, more preferably mixtures of isophoronediamine (IPDA) and diethylenetriamine (DETA).

The polyurethanes may in one preferred embodiment comprise for example 1 to 30 mol %, more preferably from 4 to 25 mol %, based on the total amount of components (b) and (d), of a polyamine having at least two isocyanate-reactive amino groups as monomer (d).

Alcohols having a functionality of more than 2, which may be used in order to set a certain degree of branching or crosslinking, include for example trimethylolpropane, glycerol, or sugars.

For the same purpose it is also possible to use, as monomers (d), isocyanates having a functionality of more than two. Examples of standard commercial compounds are the isocyanurate or the biuret of hexamethylene diisocyanate.

Suitable monomers (d) further include monoalcohols which in addition to the hydroxyl group carry a further isocyanate-reactive group, such as monoalcohols containing one or more primary and/or secondary amino groups, monoethanolamine for example.

Monomers (d), which are used optionally, are monoisocyanates, monoalcohols, and mono-primary and -secondary amines. Their fraction is generally not more than 10 mol %, based on the total molar amount of the monomers. These monofunctional compounds customarily carry further functional groups such as olefinic groups or carbonyl groups and serve to introduce into the polyurethane functional groups which facilitate the dispersing and/or the crosslinking or further polymer-analogous reaction of the polyurethane. Monomers suitable for this purpose include those such as isopropenyl-α,α-dimethylbenzyl isocyanate (TMI) and esters of acrylic or methacrylic acid such as hydroxyethyl acrylate or hydroxyethyl methacrylate.

Suitable monomers (d) further include monomers which have at least one isocyanate group or isocyanate-reactive group and another hydrophilic group, such as a non-ionic or cationic group, for example.

Suitable nonionic hydrophilic groups include, in particular, polyethylene glycol ethers composed preferably of 5 to 100, more preferably 10 to 80, repeating ethylene oxide units. The amount of polyethylene oxide units can be 0 to 10%, preferably 0 to 6%, by weight based on the amount by weight of all monomers (a) to (d).

Preferred monomers having nonionic hydrophilic groups are polyethylene oxide diols, polyethylene oxide monools, and the reaction products of a polyethylene glycol and a diisocyanate that carry a terminally etherified polyethylene glycol residue. Diisocyanates of this kind and also processes for preparing them are specified in patents U.S. Pat. No. 3,905,929 and U.S. Pat. No. 3,920,598.

Within the field of polyurethane chemistry it is general knowledge how the molecular weight of polyurethanes can be adjusted by selecting the proportions of the mutually reactive monomers and also the arithmetic mean of the number of reactive functional groups per molecule.

Components (a) to (d) and their respective molar amounts are normally chosen so that the ratio A:B, where
A is the molar amount of isocyanate groups and
B is the sum of the molar amount of the hydroxyl groups and the molar amount of the functional groups which are able to react with isocyanates in an addition reaction,
   is from 0.5:1 to 2:1, preferably from 0.8:1 to 1.5, more preferably from 0.9:1 to 1.2:1. With very particular preference the ratio A:B is as close as possible to 1:1.

The monomers (a) to (d) employed carry on average usually from 1.5 to 2.5, preferably from 1.9 to 2.1, more preferably 2.0 isocyanate groups and/or functional groups which are able to react with isocyanates in an addition reaction.

The polyaddition of components (a) to (d) for preparing the polyurethane present in the aqueous dispersions of the invention can take place at reaction temperatures of 20 to 180° C., preferably 70 to 150° C., under atmospheric pressure or under the autogenous pressure.

The reaction times required are usually in the range from 1 to 20 hours, in particular from 1.5 to 10 hours. It is known in the field of polyurethane chemistry how the reaction time can be influenced by a multiplicity of parameters such as temperature, monomer concentration, and monomer reactivity.

The reaction, i.e., the polyaddition of the monomers a), b), c), and, if appropriate, d) for the preparation of the polyurethanes, can be catalyzed with the aid of organic or organometallic compounds. Suitable organometallic compounds include dibutyltin dilaurate, tin(II) octoate or diazabicyclo[2.2.2]octane. Suitable catalysts of the reaction of the monomers a), b), c), and, if appropriate, d) and e) are also salts of cesium, especially cesium carboxylates such as, for example, the formate, acetate, propionate, hexanoate or the 2-ethylhexanoate of cesium.

Suitable polymerization apparatus for carrying out the polyaddition, i.e., the reaction of the monomers a), b), c), and, if appropriate, d) and e), includes stirred tanks, especially when a low viscosity with effective heat removal is ensured by the use of solvents.

Preferred solvents are of infinite miscibility with water, have a boiling point under atmospheric pressure of from 40 to 100° C., and react slowly if at all with the monomers.

The dispersions are normally prepared by one of the following processes:

In the acetone process an ionic polyurethane is prepared from components (a) to (c) in a water-miscible solvent which boils below 100° C. under atmospheric pressure. Water is added until a dispersion is formed in which water represents the continuous phase.

The prepolymer mixing process differs from the acetone process in that the initial preparation product is not a fully reacted (potentially) ionic polyurethane but rather a prepolymer which carries isocyanate groups. The components in this case are chosen so that the above-defined ratio A:B is greater than 1.0 to 3, preferably 1.05 to 1.5. The prepolymer is first dispersed in water and then, if appropriate, crosslinked by reaction of the isocyanate groups with amines which carry more than 2 isocyanate-reactive amino groups or chain-extended with amines which carry 2 isocyanate-reactive amino groups. Chain extension also takes place when no amine is added. In this case isocyanate groups are hydrolyzed to amino groups, which are consumed by reaction with remaining isocyanate groups of the prepolymers, thereby extending the chain.

If a solvent has been used in the preparation of the polyurethane, it is common to remove the greatest part of the solvent from the dispersion, by distillation under reduced pressure for example. The dispersions preferably have a solvent content of less than 10% by weight and are with particular preference free from solvents.

As also stated above under monomer c), the polyurethane dispersion of the invention comprises alkanolamines for the purpose of neutralizing the anionic groups.

The alkanolamines comprise at least two hydroxyl groups; preferably they comprise at least hydroxyl groups, more preferably they comprise three hydroxyl groups.

The alkanolamines are preferably of the formula

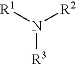

in which R1 is a hydrogen atom, a hydrocarbon group, or a hydrocarbon group which is substituted by at least one hydroxyl group, and R² and R³ are each a hydrocarbon group which is substituted by at least one hydroxyl group.

The hydrocarbon groups or hydroxyl-substituted hydrocarbon groups have preferably 1 to 10 carbon atoms, in particular 2 to 10 carbon atoms, and preferably comprise no heteroatoms other than those of the hydroxyl group.

With particular preference R1 is a C₁ to C₄ alkyl group, in particular C₂ to C₄ alkyl group, or a C₁ to C₄ alkylene group, in particular C₂ to C₄ alkylene group, that is substituted by a hydroxyl group, and R² and R³ are each a C₁ to C₄, especially C₂ to C₄, or C₂ or C₃ alkylene group that is substituted by a hydroxyl group.

Examples of preferred alkanolamines are triethanolamine and, very preferably, triisopropanolamine.

The aqueous polyurethane dispersions of the invention are suitable for use as binders for coating compositions, impregnating compositions or adhesives. The adhesives, coating compositions or impregnating compositions (aqueous compositions collectively, for short) may consist exclusively of the polyurethane dispersions, or may for these utilities comprise further auxiliaries and additives such as crosslinkers, blowing agents, defoamers, emulsifiers, thickeners, thixotropic agents, and colorants such as dyes and pigments.

The aqueous composition may comprise crosslinkers desired for the respective utility, examples being carbodiimides or aziridines.

The aqueous compositions or polyurethane dispersions are suitable for coating articles made of metal, plastic, paper, textile, leather or wood. They can be applied to these articles in accordance with the customary methods, i.e., by spraying or knife coating in the form of a film, for example, and dried. Drying may take place at room temperature or else at elevated temperature.

In particular the polyurethane dispersions of the invention are suitable for use as adhesives or else as binders for adhesives, particular preference being given to laminating adhesives. A distinction is to be made in this case between the 1K [one part, one-component] and 2K [two parts, two-component] systems.

The aqueous compositions are suitable as either 1K or 2K systems. 1K systems comprise a crosslinker and are stable under storage; in the case of 2K systems the crosslinker is not added until shortly before use.

Articles of metal, plastic, paper, leather or wood may likewise be bonded adhesively to other articles, preferably the aforementioned articles, by the aqueous dispersion of the invention being applied in the form of a film to at least one of these articles and that article then being joined with another article before or after the film has dried. In this case the film is heated preferably to temperatures from 50 to 150° C.

In the case of use as a laminating adhesive, polymeric films, paper, especially decorative papers coated or impregnated with a polymer, or leather are bonded in particular to articles made of wood, which is taken to include bound wood fiber materials such as chipboard or other boards made of cellulose materials, or to metal or plastic; for example, furniture items or furniture parts are laminated with paper or polymeric films, or interior automobile parts are laminated with polymer films.

In the case of the 1K systems it is also possible first to apply the composition of the invention to the paper or to the polymeric film that is to be laminated and then to store the coated polymeric film or paper until, at a later point in time, lamination is to take place—lamination of the furniture part or interior automobile part, for example.

The viscosity of the polyurethane dispersion of the invention is low. When the polyurethane dispersion or compositions of the invention is or are used as an adhesive, including as a laminating adhesive, assemblies of high strength are obtained, including, in particular, high thermal stability, i.e., strength at elevated temperature. The compositions of the invention are storage-stable in the form of 1K systems (crosslinker with blocked reactive groups) and can be applied to the polymeric films or paper which are intended for lamination, and stored in that form.

### EXAMPLES

The viscosity of the dispersions was measured in a Paar Physica rotational viscometer by means of the Paar Physica Viscolab LC 10 instrument at 23° C. under a shear rate of 250 s⁻¹.

### Example

### PU Dispersion with Triisopropanolamine

800 g (0.40 mol) of a polypropylene glycol with an OH number of 56, 80.48 g (0.60 mol) of dimethylolpropionic acid and 100 g of acetone are charged to a vessel, 174.16 g (1.00 mol) of tolylene diisocyanate are added at 60° C., and the mixture is stirred at 90° C. for 6 hours. Then, in succession, 800 g of acetone, 54.01 g of triisopropanolamine (TIPA) (0.240 mol) and 50 g of water are metered in, followed by a further 5 minutes of stirring. The reaction mixture is dispersed with 1600 g of water; thereafter the acetone is distilled off under reduced pressure and the solids content is adjusted to 40%.

Viscosity: 31 mPas

### Comparative Example 1 PU Dispersion with NaOH

800 g (0.40 mol) of a polypropylene glycol with an OH number of 56, 80.48 g (0.60 mol) of dimethylolpropionic acid and 100 g of acetone are charged to a vessel, 174.16 g (1.00 mol) of tolylene diisocyanate are added at 60° C., and the mixture is stirred at 90° C. for 6 hours. Then, in succession, 800 g of acetone, and a solution of 19.2 g of sodium hydroxide (0.240 mol) in 25 g of water are metered in, followed by a further 5 minutes of stirring. The reaction mixture is dispersed with 1600 g of water; thereafter the acetone is distilled off under reduced pressure and the solids content is adjusted to 40%.

Viscosity: 190 mPas

### Comparative Example 2 PU Dispersion with Tributylamine

800 g (0.40 mol) of a polypropylene glycol with an OH number of 56, 80.48 g (0.60 mol) of dimethylolpropionic acid and 100 g of acetone are charged to a vessel, 174.16 g (1.00 mol) of tolylene diisocyanate are added at 60° C., and the mixture is stirred at 92.0° C. for 6 hours. Then, in succession, 800 g of acetone, 44.49 g of tributylamine (TBA) (0.240 mol) and 50 g of water are metered in, followed by a further 5 minutes of stirring. The reaction mixture is dispersed with 1600 g of water. The batch undergoes coagulation; no useful dispersion was obtained.

### Comparative Example 3 PU Dispersion with Triethylamine

800 g (0.40 mol) of a polypropylene glycol with an OH number of 56, 80.48 g (0.60 mol) of dimethylolpropionic acid and 100 g of acetone are charged to a vessel, 174.16 g (1.00 mol) of tolylene diisocyanate are added at 60° C., and the mixture is stirred at 92.0° C. for 6 hours. Then, in succession, 800 g of acetone, 24.29 g of trethylamine (TBA) (0.240 mol) and 50 g of water are metered in, followed by a further 5 minutes of stirring. The reaction mixture is dispersed with 1600 g of water.

Viscosity: 374 mPas

TABLE
Solids content and viscosity of the polyurethane dispersions

| Batch | Base | SC [%] | Viscosity [mPas]* |
|---|---|---|---|
| Example | TIPA | 40 | 30.8 |
| Comparative Example 1 | NaOH | 40 | 190 |
| Comparative Example 2 | TBA | ./. | ./. |
| Comparative Example 3 | TEA | 40 | 374 |

*measured at 23° C. and 250 s⁻¹

### Determination of Peel Strength

For this test the polyurethane dispersion is blended 1:1 with an ethylene-vinyl acetate dispersion (Airflex® EP 17). For determining the peel strength an ABS molding is coated with the dispersion blend using a coating knife, with an applied thickness of approximately 80 μm. The coated molding is dried. In a laboratory press heated to 90° C., a commercial foamed PVC film of the kind used for laminating interior automotive parts is laminated to the coated molding under a pressure of approximately 3 bar for 30 seconds. After 3-5 days' storage of the laminate at room temperature, the peel strength of the adhesive bond is measured under a peel angle of 90° at an ambient temperature of 100° C.

| | | Peel strength at 100° C. |
|---|---|---|
| Dispersion from | Base | (N/50 mm) |
| Example | TIPA | 13 |
| Comparative example 1 | NaOH | 9 |
| Comparative example 3 | TEA | 5 |

1. A polyurethane dispersion whose polyurethane comprises anionic groups at least 10 mol % of which are neutralized by alkanolamines having at least two hydroxyl groups, excluding polyurethane dispersions comprising water-emulsifiable polyisocyanates.

2. The polyurethane dispersion according to claim 1, wherein the polyurethane is synthesized from
a) diisocyanates,
b) diols of which
b1) 10 to 100 mol %, based on the total amount of diols (b), have a molecular weight of 500 to 5000 g/mol and
b2) 0 to 90 mol %, based on the total amount of diols (b), have a molecular weight of 60 to 500 g/mol,
c) monomers other than the monomers (a) and (b), containing at least one isocyanate group or at least one isocyanate-reactive group and further carrying at least one anionic group by means of which the polyurethane is made dispersible in water, and
d) optionally, further, monofunctional or polyfunctional compounds other than the monomers (a) to (c), containing reactive groups which are alcoholic hydroxyl groups, primary or secondary amino groups or isocyanate groups.

3. The polyurethane dispersion according to claim 1, whose polyurethane contains 30 to 1000 mmol of anionic or potentially anionic groups per kg of polyurethane.

4. The polyurethane dispersion according to claim 1, wherein the alkanolamines are of the formula 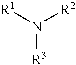
in which R1 is a hydrogen atom, a hydrocarbon group, or a hydrocarbon group which is substituted by at least one hydroxyl group, and R² and R³ are each a hydrocarbon group which is substituted by at least one hydroxyl group.

5. The polyurethane dispersion according to claim 4, wherein R¹ is a hydrogen atom, a C₁ to C₄ alkyl group, or a C₁ to C₄ alkylene group which is substituted by a hydroxyl group, and R² and R³ are each a C₁ to C₄ alkylene group which is substituted by a hydroxyl group.

6. The polyurethane dispersion according to claim 1, wherein the alkanolamine is triisopropanolamine.

7. The polyurethane dispersion according to claim 1, wherein at least 80 mol % of the anionic groups of the polyurethane are neutralized with alkanolamines.

8. The polyurethane dispersion according to claim 1, further comprising a crosslinker.

9. A binder for adhesives, coating compositions or impregnating composition comprising a polyurethane dispersion according to claim 1.
